(19) United States
(12) Patent Application Publication
(10) Pub. No.: US 2009/0251614 A1
(43) Pub. Date: Oct. 8, 2009

(54) METHOD AND APPARATUS FOR AUTOMATICALLY GENERATING A SUMMARY OF A MULTIMEDIA CONTENT ITEM

(75) Inventors: Mauro Barbieri, Eindhoven (NL); Johannes Weda, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,551

(22) PCT Filed: Aug. 23, 2007
(86) PCT No.: PCT/IB2007/053368

§ 371 Date: Feb. 24, 2009

(30) Foreign Application Priority Data
Aug. 25, 2006 (EP) 06119543.4

(51) Int. Cl. H04N 5/14

(52) U.S. Cl. 348/700; 348/E05.062

(57) ABSTRACT

A summary of a multimedia content item input at step (101) is automatically generated. A perceived pace of the content of a multimedia content item is determined, step (105). The multimedia content item comprises a plurality of segments. At least one segment of the multimedia content item is selected, step (107), to generate a summary, step (109), which has a pace similar to the perceived pace of the multimedia content item determined in step (105).

### FIELD OF THE INVENTION

The present invention relates to automatic generation of a summary of a multimedia content item. In particular, it relates to automatic generation of a summary having a pace similar to the perceived pace of a multimedia content item, for example, a video sequence such as a film, TV program or live broadcast.

### BACKGROUND OF THE INVENTION

Current hard disk and optical disk video recorders allow users to store hundreds of hours of multimedia data such as TV programs, some of these known devices generate video previews which provide the users a quick overview of the stored content, and the user can then decide whether to view the entire program. In such known devices, the recorded program is analyzed to automatically create the video preview or summary.

An important requirement that a video summary should fulfill is to recreate the atmosphere of the original program to give the users a clearer idea as to whether the program will be of interest. However, current video summary generation methods do not take the atmosphere of the original program into consideration to adapt their summary generation algorithm for each genre and type of program. Therefore, the user, on viewing the summary, may have no clear idea of the type of program and whether it is of interest.

### SUMMARY OF THE INVENTION

Therefore, it would be desirable to have a summary generation system and method that can generate a summary that reflects the atmosphere of a multimedia content item such as a film or TV program: a summary that induces in the audience an idea of the type of program.

This is achieved, according to a first aspect of the present invention, by a method of automatically generating a summary of a multimedia content item, the method comprising the steps of determining a perceived pace of the content of a multimedia content item, the multimedia content item comprising a plurality of segments; selecting at least one segment of the multimedia content item to generate a summary of the multimedia content item such that a pace of the summary is similar to the determined perceived pace of the content of the multimedia content item.

This is also achieved, according to a second aspect of the present invention, by apparatus for automatically generating a summary of a multimedia content item comprising: a processor for determining the perceived pace of the content of a multimedia content item, the multimedia content item comprising a plurality of segments; a selector for selecting at least one segment of the multimedia content item to generate a summary of the multimedia content item such that a pace of the summary is similar to the determined perceived pace of the content of the multimedia content item.

The atmosphere of the program is determined to a large extend by the pace of the program. According to the present invention, a summary is automatically generated mimics the original perceived pace of the multimedia content item and therefore provides users a better representation of the real atmosphere of the item (film or program etc.). For example, a slow pace if the film has a slow pace (for example romantic films) and a fast pace if the film has a fast pace (for example action films).

The perceived pace of the content of the multimedia content item may be determined on the basis of shot duration, motion activity and/or audio loudness. Directors set the pace of a film during editing by adjusting the duration of the shots. Short shots induce in the audience a perception of action and fast pace. On the contrary, long shots induce in the audience a perception of calm and slow pace. As a result the perceived pace of the multimedia content item can be determined simply from the shot duration distribution. Further, motion activity is greater in a fast pace multimedia content item and audio loudness is, invariably, greater in a face fast pace multimedia content item. Therefore, the perceived pace of a multimedia content item can be easily derived from these characteristics.

If determined on the basis of shot duration, the perceived pace may be determined from a distribution of shot duration. The distribution may be determined from a count of shot durations within a range to form a histogram or, alternatively, from an average of the shot durations and its standard duration or alternatively, other higher order moments may be computed. Algorithms for detecting shot boundaries are well known and therefore the shot durations and hence their distribution can be easily and simple derived using simply statistical techniques.

Selecting at least one segment for the summary may be achieved by extracting at least one content analysis feature for each segment, allocating a score to each segment that is a function of the extracted content analysis feature and selecting that segment that maximizes the score function. Alternatively, the segment can be selected such that the selected segments give a pace distribution over the duration of the summary similar to that of the perceived pace distribution over the whole content item.

### BRIEF DESCRIPTION OF DRAWINGS

For a more complete understanding of the present invention, reference is now made to the following description taken in conjunction with the accompanying drawing, in which:

FIG. 1 is a flow chart of the method steps according to a preferred embodiment of the present invention.

### DETAILED DESCRIPTION OF EMBODIMENTS OF THE INVENTION

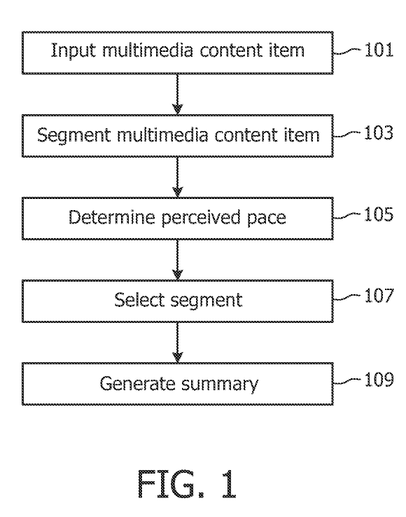

With reference to FIG. 1, embodiments of the present invention will be described. A multimedia content item such as a film, TV program or live broadcast is input, step 101. For example, in the case of a video recorder, the multimedia content item is recorded and stored on a hard disk or optical disk etc. The multimedia content item is segmented, step 103. The segmentation is, preferably on the basis of shots. Alternatively, the multimedia content item may be segmented on the basis of time slots. The perceived pace of the multimedia content item is determined, step 105. Segments are then selected, step 107 to generate the summary, step 109 such that the summary has a similar pace to that of the perceived pace of the multimedia content item.

The step of determining the perceived pace will now be described in more detail.

In accordance with a first embodiment of the present invention, the perceived pace of the multimedia content item is determined by a shot duration distribution.

Firstly, shot boundaries are detected using any well-known shot cut detection algorithm Having the location of the shot boundaries, the shot duration are computed. The distribution of shot duration is analyzed by counting how many shots in the video program fall within predefined ranges. In this way, a histogram of the shot duration distribution is constructed in which each bin represents a particular shot duration range (e.g. less than 1 second, between 1 and 2 seconds, between 2 and 3, etc.). The value of a histogram bin represents the number of shots found with a particular duration that corresponds to the duration limits of the histogram bin.

Other ways of modeling a distribution are also possible. For example, in a simpler embodiment the shots duration distribution can be modeled using the shots duration average and standard deviation. In another embodiment in addition to the standard deviation other higher order moments could be computed.

From the shot duration distribution, the perceived pace of the multimedia content item is determined.

The multimedia content item is then segmented. This may be based on the detected shot boundaries. Alternatively, the multimedia content item may be segmented in predefined time slots or on the basis of content analysis.

In accordance with a second embodiment, the perceived pace of the multimedia content item is not only derived from the duration of the shots (shot duration distribution) but also by the amount of motion and audio loudness. For example, the increase in motion and audio loudness indicated an increase in the perceived pace. Use of motion and audio loudness to derive the perceived pace is disclosed in chapter 4, pages 58-84 of “Formulating Film Tempo” in “Media Computing—Computational Media Aesthetics”; Adams B., Dovai C., Venkatesh S., edited by Chitra Dorai, Svetha Venkatesh, Kluwer Academic Publishers, 2002.

In an alternative embodiment the perceived pace can be determined from a perceived pace distribution. This can modeled by first calculating a measure of the perceived pace and then extracting its distribution among the shots.

After the perceived pace or perceived pace distribution has been computed (either using shots duration distribution or by computing the pace function) the method of the present invention selects the segments which best matches the perceived pace or distribution summary.

In accordance with a first alternative, selection of the segments is made by use of a importance score function.

In current methods for automatic video generation summary has a numerical score (importance score) associate therewith. This score is a function of content analysis features (CA features) extracted from the content (e.g. luminance, contrast, motion, etc.). Segment selection involves choosing segments that maximize the importance score function. The importance score function of a summary, I_{summary} can be represented as a function F of the content analysis features of the summary, CA features summary as follows:

I_{summary}=F(CA features summary)

To generate a summary that also mimics the perceived pace of the multimedia content item (or original program) a penalty score that is the distance between the original program pace distribution Ψ_{program} and the summary pace distribution Ψ_{summary} is subtracted giving an importance score as follows:

I_{summary}=F(CA features summary)−α·dist(Ψ_{summary}−Ψ_{program})
Wherein dist(Ψ_{summary}−Ψ_{program}) is a non-negative value that represents the difference between the original program pace distribution and the summary pace and α is a scaling factor used to normalize the distance between distribution and make it comparable to the typical values assumed by the function F.
dist(Ψ_{summary}−Ψ_{program}) can be any distance measure between distributions such as L1, L2, histogram intersection, earth movers distance, etc. In case the distributions are modeled using simple shots duration averages, the distance is simply:

dist(Ψ_{summary}−Ψ_{program})=| d̅_{summary}− d̅_{program}|
wherein d̅_{summary} is the average shot duration in the summary and d̅_{program} is the average shot duration of the multimedia content item. The segments can then be selected to maximize the importance score I_{summary}.

In accordance with a second alternative, selection of the segments is made by pre-allocation of the segments.

Given the perceived pace distribution of the content of the multimedia content item and the desired duration of the summary, a new pace distribution that has the same shape of the perceived pace distribution is created for duration of the summary. Segments are the selected from the multimedia content item that fit with the newly created distribution. The newly created distribution indicates for each pace range the number of shots that have to be chosen with that particular pace. The selection procedure chooses for each pace range the shots with the highest importance score (according to known summarization methods), until the allocated amount is reached. In this way a summary is created that has the same pace distribution as the multimedia content item.

For example, suppose the multimedia content item consists for 30% of shots shorter than 3 seconds, 60% of shots with duration between 3 and 8 seconds, and 10% of shots longer than 8 seconds and the summary is to be 100 seconds long.

As a result, 30 seconds of the summary needs to be composed of short shots (shorter than 3 seconds), 60 seconds needs to be composed of shots with a duration between 3 and 8 seconds, and 10 seconds needs to be composed of long shots (longer than 8 seconds).

In accordance with the method of the present invention, the shots with the highest importance score that are shorter than 3 seconds until the required 30 seconds are filled are selected. The same method is then repeated for the shots with duration between 3 and 8 seconds, and for the long shots (longer than 8 seconds).

Tolerances margins can also be introduced. In the previous example, 10 seconds were allocated for long shots (longer than 8 seconds). It is clear that only one shot can be selected. This shot does not necessarily have to be exactly 10 seconds, but, for example, also 9 or 12 seconds are allowable.

Although preferred embodiments of the present invention have been illustrated in the accompanying drawing and described in the foregoing description, it will be understood that the invention is not limited to the embodiments disclosed but is capable of numerous modifications without departing from the scope of the invention as set out in the following claims.

1. A method of automatically generating a summary of a multimedia content item, the method comprising the steps of:
determining a perceived pace of the content of a multimedia content item, said multimedia content item comprising a plurality of segments;
selecting at least one segment of said multimedia content item to generate a summary of said multimedia content item such that a pace of said summary is similar to said determined perceived pace of the content of said multimedia content item.

2. A method according to claim 1, wherein said perceived pace of the content of said multimedia content item is determined on the basis of at least one of shot duration, motion activity and audio loudness.

3. A method according to claim 2, wherein said perceived pace of the content of said multimedia content item is determined on the basis of at least one of shot duration by determining a distribution of the durations of the shots of the content of said multimedia content item.

4. A method according to claim 3, wherein determining the distribution of the durations of the shots of the content of said multimedia content item comprises the steps of:
detecting shot boundaries of the content of said multimedia content item; and
determining distribution by counting the number of shots having a duration within a predetermined range or by averaging the shot durations and calculating the standard deviations of said shot durations.

5. A method according to claim 1, wherein the step of selecting at least one segment of said multimedia content item includes the steps of:
extracting at least one content analysis feature for each segment of said multimedia content item;
allocating a score to each segment that is a function of said extracted content analysis feature; and
selecting at least one segment that maximizes the score function.

6. A method according to claim 1, wherein the step of selecting at least one segment of said multimedia content item includes the steps of:
determining a distribution of perceived pace over the whole multimedia content item;
determining a duration of said summary; and
selecting at least one segment of said multimedia content item having a pace distribution over said determined summary duration similar to the determined perceived pace distribution of said multimedia content item.

7. A computer program product comprising a plurality of program code portions for carrying out the method according to claim 1.

8. Apparatus for automatically generating a summary of a multimedia content item comprising:
a processor for determining a perceived pace of the content of a multimedia content item, said multimedia content item comprising a plurality of segments;
a selector for selecting at least one segment of said multimedia content item to generate a summary of said multimedia content item such that a pace of said summary is similar to said determined perceived pace of the content of said multimedia content item.
